(19) United States
(12) Patent Application Publication
(10) Pub. No.: US 2009/0309555 A1
(43) Pub. Date: Dec. 17, 2009

(54) ELECTRICITY EFFICIENCY IMPROVING APPARATUS

(76) Inventors: Iksung Richard Hur, Irvine, CA (US); Dong Hoon Min, Anyang-Si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/486,628

(22) Filed: Jun. 17, 2009

Related U.S. Application Data
(60) Provisional application No. 61/073,249, filed on Jun. 17, 2008.

(51) Int. Cl. G05F 3/00

(52) U.S. Cl. 323/205

(57) ABSTRACT

A system and method for improving the electrical efficiency of an electrical load are provided. In an embodiment, a device is coupled to a load and its power source via an electrical conductor. The device optimizes the power delivered from the power source to the load by compensating or removing distortions in the matter wave of the electrical energy delivered from the power source. In some embodiments, the device employs infrared radiating materials that surround selected areas of the conductor. The infrared radiation may be of a wavelength and frequency that help restore the matter waves of the electrical energy and increase power factor of the load. Additionally, the device can be configured to modify the matter wave properties of the conductor itself to minimize its effects. For example, the infrared radiation emitted from the device may provide destructively interference energy that reduces vibrations of atoms inside the conductor.

### CROSS-REFERENCE TO RELATED APPLICATION

This application claims the benefit of U.S. Provisional Application No. 61/073,249, filed Jun. 17, 2008, which is herein incorporated by reference in its entirety.

### BACKGROUND

1. Field

The present disclosure relates to a device, system, and methods of improving electrical efficiency of electrical equipment.

2. Description of Related Technology

Efficiency of electrical equipment is highly desired, for example, due to the expense of electricity. One measure of efficiency for AC electrical equipment is known as power factor. The power of an AC electrical system is defined as the ratio of the real power flowing to the load to the apparent power. Power factor (PF) can be expressed as a number between 0 and 1 or is frequently expressed as a percentage, e.g. 0.5 PF=50% PF.

Real power is the capacity of the circuit for performing work in a particular time. Apparent power is the product of the current and voltage of the circuit. A low power factor (i.e., less efficient) system draws more current than a load with a high power factor for the same amount of useful power transferred. These higher currents mean that more power is lost and larger wires and other equipment may be required. Because of the costs of larger equipment and wasted energy, maintaining a high power factor can be highly desirable.

Various devices for increasing or correction power factor are known. For example, electrical equipment with low power factor can be corrected using, for example, a passive network of capacitors and/or inductors. However, the known power saving equipment often have complex circuits and can be expensive to manufacture and maintain. Furthermore, it is very difficult to make power saving equipment that is suitable for home use.

### SUMMARY

In one embodiment, a correction device is configured to be coupled to an electrical system. The device comprises: a set of conductor wiring conducting electricity from the electrical system, wherein the electricity comprises electrons propagating as a matter wave; and a set of infrared radiation emitters irradiating selected regions of the conductor wiring with infrared radiation having one or more wavelengths that are substantially the same as wavelengths of matter waves of the electrons passing through the conductor wiring.

In another embodiment, an electrical system comprises: a power source providing electricity comprising electrons propagating as a matter wave; at least one correction device configured to receive at least a portion of the electron matter wave, modify the electron matter wave in the electricity based on irradiating infrared radiation into a portion of the electrical system; and at least one load configured to perform work with the modified electricity.

In another embodiment, a method of improving electrical efficiency is provided. The method comprises: receiving electricity from a power source, wherein the electricity comprises electrons propagating as a matter wave in a conductor; exposing a region of the conductor to infrared radiation at sufficient power and at least one wavelength that modifies the electricity based on compensating for distortions in the matter wave caused by the propagation through the conductor; and providing the modified electricity to a load.

### BRIEF DESCRIPTION OF THE DRAWINGS

The present disclosure will be described more fully hereinafter with reference to the accompanying drawings, in which embodiments of the disclosure are shown. In the Figures:

FIG. 1 shows an embodiment of an electrical efficiency improving system

FIG. 2 shows an embodiment of the PF correction device.

FIG. 3 shows an internal structure embodiment of the PF correction device.

FIG. 4 shows an embodiment of coating of a conductor electrode of the PF correction device.

The size and thickness of the elements shown in the drawings are for better understanding and ease of description, and the present disclosure is not necessarily limited thereto. Parts that are not important in the description are omitted in the drawings for clear description of the present disclosure, and like reference numerals designate like elements throughout the specification. Further, in the drawings, the thickness of layers, films, panels, regions, etc., are exaggerated for clarity.

### DETAILED DESCRIPTION

Electricity is a form of electromagnetic energy and exhibits the characteristics of a matter wave or De Broglie matter wave. A matter wave is a well known phenomenon of quantum mechanics in which particles, like electrons, possess a wave/particle duality. In other words, electrons behave as both a particle and as a wave. As part of a matter wave, the movement of electrons for electricity through a conductive medium is dependent on factors, such as energy states of the electrons, the characteristics of the conductive medium, and other environmental conditions like temperature.

In accordance with the principles of the present invention, the efficiency of electricity have been found to be closely related to the resonance frequency of an electron matter wave and the vibration of the lattice structure of the conductive medium. Therefore, in order to maximize the efficiency of electricity, one principle of the present invention is to optimize the movement of electrons in the conductive medium and minimized resistance in the medium to the electron matter wave due to vibrations of the lattice structure of the medium.

Embodiments of the present invention provide a system and method for improving the electrical efficiency of an electrical load. For example, in some embodiments, the power factor of an AC electrical load may be increased. In an embodiment, a device is coupled to the load and its power source via an electrical conductor. The device optimizes the power delivered from the power source to the load by compensating or removing distortions in the matter wave of the electrical energy delivered from the power source. These distortions can occur as the matter wave of the electrical energy propagates through the conductor. In some embodiments, the device employs infrared radiating materials that surround areas selected areas of the conductor. The infrared radiation may be of a wavelength and frequency that help restore the matter waves of the electrical energy and increase the power factor of the system. Furthermore, in another embodiment, the device can be configured to modify the matter wave properties of the conductor itself to minimize its effects. For example, the infrared radiation emitted from the device ma y provide destructively interference energy that reduces certain vibrations of the atoms inside the conductor wiring.

In some embodiments, a power factor (PF) correction device is coupled to an electrical system. The PF correction device provides correcting energy to the system that optimizes the movement of the electricity's electron matter wave and/or minimizes the resistance of the conducting medium carrying the electricity. For example, in some embodiments, the PF correction device provides correcting energy in the form of infrared radiation to the system. The PF correction device can provide correcting energy having a resonance frequency that matches the wave characteristics of the electron matter wave in the conductive medium. Accordingly, based on constructive and/or destructive interference, the correcting energy affects the electron movement in the conductive medium by resonance energy absorption. Furthermore, the correcting energy can configured to minimize the lattice vibrations in atoms of the conductive medium, and thus, reduce the resistance of the conductive medium. The PF correction device may be at located a central or distinct location in the system, or spread out with multiple components over a distribution system, or built into the power-consuming equipment itself.

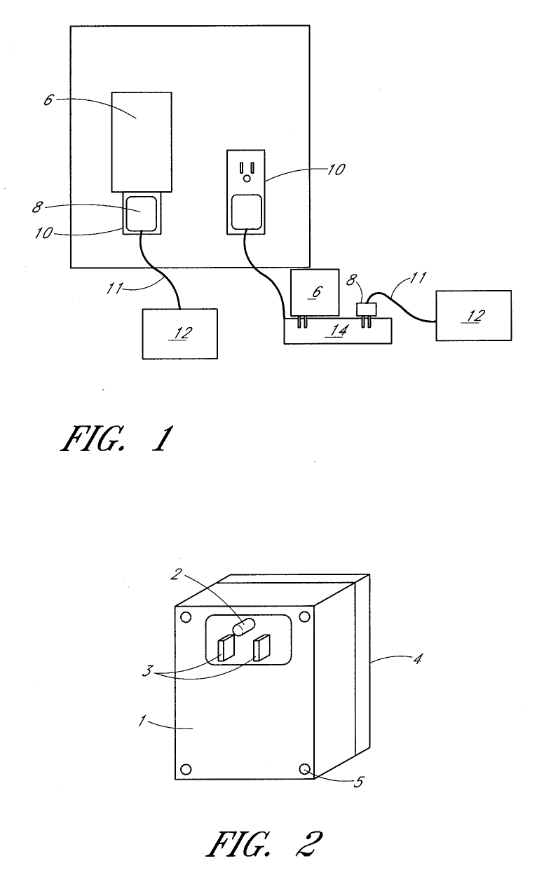

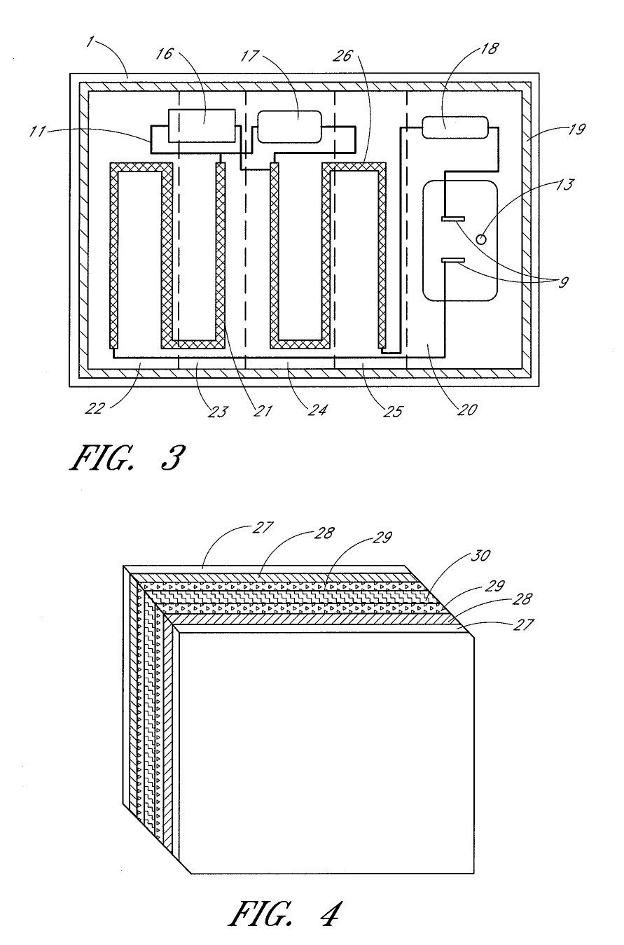

FIG. 1 shows an embodiment of an electrical efficiency improving system. FIG. 2 shows an embodiment of the PF correction device. FIG. 3 shows an internal cross section of an embodiment of the PF correction device and FIG. 4 shows an embodiment of coating of a conductor electrode of the PF correction device.

As those skilled in the art will realize, the described embodiments may be modified in various different ways, all without departing from the spirit or scope of the present disclosure. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

FIG. 1 shows an embodiment of the system of the present disclosure that includes a PF correction device and FIG. 2 shows an embodiment of a PF correction device. For convenience, FIGS. 1 and 2 will now be further described.

As shown, in FIGS. 1 and 2, the system may comprise a PF correction device 6, a power terminal 10, and a load 12. Each of these components will now be briefly described.

The power correction device 6 may comprise includes a housing 1, ground plug 2, power plugs 3, housing cover 4, and screws 5. The housing 1 is configured to enclose inner components of the PF correction device 6. The inner components of the device 6 are inserted into the housing 1 through an opening of the housing 1. The cover 4 is configured to cover the opening of the housing 1. The screws 5 are used to hold the cover 4 with the housing 1. The ground plug 2 and power plugs 3 are extended out of the housing 1, so that they can be connected to the power terminal 10. In some embodiment, a sealing rubber can be between the housing 1 and the cover 4 in order to protect the inside of the housing 1 from moisture.

In one embodiment, the housing 1 and the cover 4 can be made of plastic. In other embodiments, the housing 1 and the cover 4 can be made with metals. Although not illustrated, electrically conducting cables can be used instead of power plugs 3 to connect to the power terminal 10. In some embodiments, the housing 1 and the cover 4 can be manufactured to snap fit together without using fasteners or screws.

The power terminal 10 serves as the electrical power source of the system or couples the system to a power source. For example, as shown in FIG. 1, the power terminal 10 is illustrated as an electrical outlet. In some embodiments, the power terminal 10 can be an electric outlet in a building, a power distribution box providing power to a building, or a transformer. In some embodiments, electricity to the power terminal 10 is provided from a power plant. In other embodiments, electricity to the power terminal 10 is provided by a portable power source, such as a battery.

The load 12 represents generally the load on the system, such as a device that performs work. As shown, in FIG. 1, the load 12 can connected to the power terminal 10 via an electric adapter 8 and electric cable 11. For example, for purposes of illustration, the load 12 is shown as an electric appliance, such as a washing machine, and the like. Any type of electrical load can be implemented in the system. In addition, the load may be of any size from a large appliance or even a building to a relatively small device or home appliance. FIG. 1 shows two ways the PF correction device 6 and the load 12 can be connected. On the left side of FIG. 1, the PF correction device 6 is connected to a socket of the electrical terminal 10 and the load 12 is electrically connected to another socket of the same electrical terminal 10. In other words, the PF correction device 6 and load 12 are connected in parallel. In some embodiments, the PF correction device 6 and the load 12 may be electrically coupled, but physically spaced apart from each other. For example, the PF correction device 6 and the load 12 can each be connected to different outlets that are a certain distance away. In some embodiments, the PF correction device 6 may effectively increase the power factor of a load 12 that is physically substantially spaced apart, such as up to about 100 ft, about 50 ft, etc. Any distance may be implemented in the embodiments. In some embodiments, there may be a plurality of loads in connection with the PF correction device 6.

On the right side of FIG. 1, the PF correction device 6 is connected to a multi-tap 14 with the load 12. The multi-tap 14 is connected to the power terminal 10 and the PF correction device 6 and the load 12 are connected to the multi-tap 14. The PF correction device 6 and the load 12 are again shown being connected in parallel. Although not illustrated, the PF correction device 6 can also be connected directly to the load 12 in series or incorporated as component of the load 12.

During operation, as electricity flows through the system, the matter waves of the electrons may be distorted due to collisions of electrons with atoms of the power cable's materials, where the power cable is a conductive medium for movement of electrons. These collisions can impede and slow the propagation of electrons and cause scattering of the electrons through the power cables. This distortion of the matter waves of the electrons and resistance within the power cables lead to decreased electrical efficiency, such as a lower power factor.

Accordingly, in one embodiment, the PF correction device 6 is configured to improve the electrical efficiency of the system by increasing its power factor. In some embodiments, the PF correction device 6 includes one or more conductor electrodes through which electricity of the system flows. In addition, surrounding at least a portion of these conductor electrodes at various regions, the PF correction device 6 includes infrared radiating material.

In some embodiments, the infrared radiating materials of the PF correction device 6 emit infrared energy. For example, the infrared energy can be far-infrared and/or near-infrared energy. This energy may be configured to correct or restore the electron matter waves, for example, to their original state from the power terminal 10 or power source. The energy from the infrared radiation may improve the power factor of the system because they are at least partially in-phase with the electron matter waves. The use of infrared energy in the embodiments is provided by way of example to illustrate some embodiments. However, embodiments of the present invention are not limited to infrared energy and other embodiments may also employ different wavelengths of electromagnetic energy.

Further, in another embodiment, the PF correction device 6 can be configured to modify the matter wave properties of the conductor electrode itself to minimize its effects. For example, the infrared radiation emitted from the infrared radiating materials can be configured to provide destructive interference energy that reduces certain vibrations of the atoms inside the conductor electrode. In particular, the waves of the infrared energy from PF correction device 6 can be controlled to be out-of-phase with the vibrations of the atoms inside the conductor electrode. By reducing the vibration of the atoms inside the conductor electrode, the electrons flow faster through the conductor electrode with reduced scattering. In turn, the power factor of electricity through the PF correction device 6 is improved. The PF correction device 6 is further described with reference to FIGS. 3 and 4.

Various tests of some embodiments were performed, for example, using a washing machine as the load. The test results of the PF correction device 6 are now provided below in Table 1. In Table 1, “Saver Type” indicates various embodiment of the PF correction device 6 and “No.” indicates number of test trials for each type.

TABLE 1

| | | Power | Saving | Avg. | Ave. | Elapsed | E/Time | | |
|---|---|---|---|---|---|---|---|---|---|
| Type | No. | (wh) | (%) | Voltage | Ampere | Time (sec) | (sec) | 120 V fixed | |
| No | 1^{st} | 694.1 | No Load | 119.40 | 3.587 | 6280 | No Load | 697.59 | No Load |
| Correction | 2^{nd} | 787.4 | Average | 116.74 | 5.640 | 6419 | Average | 809.39 | Average |
| | 3^{rd} | 792.8 | Power | 120.08 | 4.675 | 6259 | E/Time | 792.27 | Power (wh) |
| | 4^{th} | 662.4 | (wh) | 119.84 | 4.421 | 6392 | 6356 | 663.28 | 726.4 |
| | 5^{th} | 664.3 | 720.2 | 119.10 | 4.052 | 6430 | | 669.32 | |
| Example 1 | 1^{st} | 663.0 | 7.94% | 119.21 | 5.086 | 6180 | −176 | 667.39 | 8.12% |
| | 2^{nd} | 583.6 | 18.97% | 118.48 | 3.651 | 6699 | 343 | 591.09 | 18.62% |
| Example 2 | 1^{st} | 709.0 | 1.56% | 118.20 | 3.396 | 6407 | 51 | 719.80 | 0.90% |
| Example 3 | 1^{st} | 649.9 | 9.76% | 120.26 | 3.988 | 6319 | −37 | 648.49 | 10.72% |
| | 2^{nd} | 593.3 | 17.62% | 118.25 | 4.075 | 6439 | 83 | 602.08 | 17.11% |
| | 3^{rd} | 594.0 | 17.52% | 119.19 | 4.620 | 6395 | 39 | 598.04 | 17.67% |
| | 4^{th} | 635.6 | 11.75% | 119.10 | 3.309 | 6220 | −136 | 640.40 | 11.84% |
| Example 4 | 1^{st} | 677.8 | 5.89% | 118.44 | 4.120 | 6699 | 343 | 686.73 | 5.46% |
| Example 5 | 1^{st} | 701.7 | 2.57% | 119.19 | 4.620 | 6339 | −17 | 706.47 | 2.74% |

FIG. 3 shows an internal structure of an embodiment of the PF correction device 6. As shown, the PF correction device 6 is electrically coupled to the system via terminal connector 9 to receive the electricity from the power terminal 10 or from a power source. As also shown, the PF correction device 6 can optionally include a ground connector 13 connector.

Internally, the PF correction device 6 may comprise a condenser 16, a variable resistor (varistor) 17, a fuse 18, a metal shield layer 19, infrared (IR) radiating material 20, a first electrode 21, regions 22, 23, 24, and 25, and a second electrode 26. The housing 1 encloses these components of the PF correction device 6.

The condenser 16 provides a stable voltage within the PF correction device 6. For example, the condenser 16 may be implemented as a capacitor or other type of component.

The varistor 17 acts as a surge protector for the PF correction device 6. For example, when needed, the varistor 17 can shunt the current created by a high voltage transient away from the other components of the PF correction device 6. The varistor 17 can be a metal oxide type varistor that are known to those skilled in the art. In the embodiment shown, the varistor 17 and the condenser 16 are connected in series with the first and second electrodes 26 and 21.

The fuse 18 is configured to interrupt excessive current from the power terminal 10 to the PF correction device 6 and protect the circuit of the PF correction device 6. For example, the fuse 18 can be connected to the first electrode 26 or the second electrode 21. In one embodiment, the fuse 18 is interposed between one end of the terminal connector 9 and the first electrode 26.

The metal shield layer 19 provides some shielding to eliminate unnecessary charge carriers or noise and/or may provide additional structural protection for the PF correction device 6. In some embodiments, the metal shield layer 19 can be inserted around the inside of the housing 1.

The infrared radiating material 20 provides the electromagnetic energy that corrects or restores the electron matter wave of the electricity being carried by the system through the PF correction device. In one embodiment, the infrared radiating material 20 surrounds at least portions of the first and second electrodes 26 and 21. For example, the infrared radiating material 20 can be applied as a putty material to fill inside the housing 1 around the electrodes 26 and 21 in regions 22-25. In one embodiment, the infrared radiating material 20 can emit far-infrared rays. The materials and structure of the infrared radiating material 20 are described further below and with reference to FIG. 4.

The first electrode 26 and second electrode 21 electrically couple the PF correction device 6 to the system and load 12. In one embodiment, electrodes 21 and 26 are connected in series with the varistor 17 and the condenser 16.

The lengths and shapes of the electrodes 26 and 21 can be optimized to provide large surface area that is exposed to the infrared radiation from the infrared radiating material 20. The lengths of the electrodes 26 and 21 are configured to allow the infrared radiating materials 20 to provide energy to electrons, as well as reduce vibration of the atoms inside the electrodes 26 and 21. For example, the lengths of the electrodes 26 or 21 combined to provide a surface are of about 300 cm² for a system designed to couple with the load 12 that is an appliance. In other embodiments, such as for larger load commercial applications, the surface areas of the electrodes 26 and 21 combined can be much larger, such as from about 500 cm² to about 200 cm².

The electrodes 26 and 21 can be arranged in various shapes to increase the length of the electrodes that can be fitted inside the PF correction device 6. In the illustrated embodiment, the electrodes 26 and 21 are arranged in overlapping U-shapes. In other embodiment, the electrodes 26 and 21 can be arranged in a spiral, a zigzag, etc. Other shapes that maximize the length and surface area of electrodes 21 and 26 can be implemented in other embodiments.

In one embodiment, the cross-sections of the electrodes 26 and 21 can be rectangular. In other embodiments, the cross-sections can be circular or any other arbitrary shape. The thickness (or diameter) of the electrodes 26 and 21 can be from about 0.5 mm to about 0.7 mm for system designed to couple with the load 12 that is an appliance. In other embodiments, such as for larger load commercial applications, the thickness of the electrodes 21 and 26 can be from about 1.0 mm to about 1.5 mm. In some embodiments, the electrodes 26 and 21 are made from conducting metals, such as copper. In one embodiment, the electrodes 21 and 26 are constructed from substantially pure copper of 99.97% purity.

An example of how infrared radiation can improve the electrical efficiency and power factor of an electrical system the following derivation is provided below. The derivation assumes a copper conductor, but one skilled in the art will recognize that the embodiments can be applied to any type of conductor.

The Debye frequency (i.e., the maximum theoretical frequency for the atoms that make crystal) of copper is calculated by the formula KB⊖ D=hω D (KB: Bolzmann's constant, ⊖ D: Debye temperature, h: (h/2π, h: Plank's constant), and ω D: Debye frequency). The Debye frequency of copper is approximately 4.74×10¹³ Hz in case of single crystal, but can be different in cases of a polycrystalline structure of actual metals as the value may have some range depending on the composition of the metal and surrounding environment.

The frequency and wave length of De Broglie wave for the electron wave of the electricity can be calculated according to the following formula:

f=E/h=1/(1−v²/c²)/^{1/2}·mc²/h, λ=h/p=h/mv·(1−v²/c²)^{1/2}

where f: frequency, E: energy, v: moving velocity of mass, c: light speed, m: mass, and p: momentum. Assuming an ideal metal and a single crystal structure, the wave length of an electron is approximately 0.12 nanometers (in the case of electron beam when accelerated by 100 volts) and the frequency is approximately 2.48×1018 Hz. However, their actual results in actual metals may differ from these calculations using the above formula. Actual results will be low compared to the theoretical value calculated from a single crystal, because real copper is generally polycrystalline and has foreign materials and defects inside. This means that the electrons move in some complex potential well generated by metal atoms, defects, grain and boundaries with specific kinetic energy. The wavelength of electrons moving in metal will be in some range which possibly makes resonance absorption with the infrared radiation.

Nonetheless, the wavelength of electrons moving in a copper conductive medium can be predicted to be in a certain range. This range has also been found to be responsive to resonance absorption with the infrared radiation.

Some examples of the infrared radiating materials 20 that produce effective infrared radiation are listed in Table 2 below. In the various embodiments, these materials can be mixed in certain proportions with one another to control the wavelengths of the infrared radiation emitted. As shown below, the emissivity of the radiating materials 20 are generally from about 0.80 to about 0.90 at reference temperature of 300° C.

TABLE 2

| | Emissivity of | | Emissivity of |
|---|---|---|---|
| | wavelengths of | Emission power | wavelengths of |
| Sample | 3~20 μm | (W/m² · μm @300 C.) | 3~6 μm |
| SiO₂(micron) | 0.898 | 50.120 × 10² | 0.80< |
| SiO₂(nano) | 0.906 | 50.294 × 10² | 0.80< |
| Silica | 0.781 | 43.359 × 10² | 0.50~0.70 |
| Kiyoseki | 0834 | 46.277 × 10² | 0.50~0.60 |
| CaCO₃ | 0.801 | 44.442 × 10² | 0.50~0.60 |
| TiO₂ | 0.763 | 42.357 × 10² | 0.60~0.80 |
| Al₂O₃ | 0.750 | 40.121 × 10² | 0.42~0.62 |
| MgO | 0.708 | 39.321 × 10² | 0.30~0.45 |
| Fe₂O₃ | 0.693 | 38.458 × 10² | 0.32~0.43 |
| SiO₂: Kiyoseki | — | — | |
| SiO₂: Silica | — | — | |

In one embodiment, there are one or more infrared radiating regions, e.g., regions 22-25, of infrared radiating material 20 inside the PF correction device 6. Each region of material 20 may emit different wavelengths and intensity of infrared radiation. This variation in each region may be useful to compensate for the differences in the matter waves of the electrons and/or wavelengths of the vibration of the atoms inside the conductor electrodes 26 and 21.

In the illustrated embodiment, the PF correction device 6 comprises four regions 22, 23, 24, and 25. Of course, the PF correction device 6 may comprise any number of regions.

The regions 22, 23, 24, and 25 can be configured with specific sizes and/or surface areas of the electrodes 26 and 21 depending on the desired correction to the electron matter wave being carried. In addition, the wavelengths of the infrared radiation from these regions may vary from one another, such as increasing from one region to next.

In some embodiments, the wavelengths of the infrared radiation in the regions 22, 23, 24, and 25 can be from about 2 μm to about 20 μm. For example, region 25 can emit infrared radiation with wavelengths from about 2 μm to about 5 μm, region 24 can emit infrared radiation with wavelengths from about 6 μm to about 10 μm, region 23 can emit infrared radiation with wavelengths from about 10 μm to about 15 μm, and region 22 can emit infrared radiation with wavelengths from about 15 μm to about 20 μm. The wavelengths of the infrared radiation from each region can be arranged so that each region emits wavelengths in random order, or in decreasing order from one region to the next.

Some examples of infrared radiating materials used in each region of the PF correction device 6 are shown in Table 3 below. One or more compounds can be included in many different combinations in table below. In Table 3, term “RG” refers to different regions of the infrared radiating material 20 and “Base” refers to base filler material that may be used in the PF correction device 6.

TABLE 3

| | | Compounds | | | | | | | |
|---|---|---|---|---|---|---|---|---|---|
| | | SiO₂ | TiO₂ | Silica | CaCO₃ | Al₂O₃ | Fe₂O₅ | MgO | Kiyoseki |
| | | 30~80 | 5~10 | 5~10 | 10~40 | 5~10 | 5~10 | 5~10 | 20~30 |
| Example 1 | RG I | 70.0 | | | | | | | 30.0 |
| | RG II | 30.0 | | | 40.0 | | | | 30.0 |
| | RG III | 40.0 | | | 30.0 | | 10.0 | | 20.0 |
| | RG IV | 30 | | 10 | 10 | 10 | | 10 | 30 |
| Example 2 | Base | 71.5 | | | | | | | 28.5 |
| | RG I | 50.0 | | | 50.0 | | | | |
| | RG II | | | 50.0 | 50.0 | | | | |
| | RG III | 33.4 | | | | | 33.3 | | 33.3 |
| Example 3 | Base | 100 | | | | | | | |
| | RG I | 40.0 | | 20.0 | | | | | 40.0 |
| | RG II | | | 50.0 | | | | | 50.0 |
| | RG III | — | — | — | — | — | — | — | — |
| | RG IV | — | — | — | — | — | — | — | — |
| Example 4 | Base | 100 | | | | | | | |
| | RG I | 50.0 | | 50.0 | | | | | |
| | RG II | | | 50.0 | 50.0 | | | | |
| | RG III | 40.0 | | | | | 20.0 | | 40.0 |
| | RG IV | 33.4 | | | | | 16.6 | | 50 |
| Example 5 | Base | 100 | | | | | | | |
| | RG I | 50.0 | | | 50.0 | | | | |
| | RG II | 69.4 | 11.2 | | 44.4 | | | | |
| | RG III | 33.4 | 16.7 | | | | 16.7 | | 33.2 |
| | RG IV | 33.4 | | | | | 16.6 | | 50.0 |
| Example 6 | Base | 100 | | | | | | | |
| | RG I | 40.0 | | 20.0 | | | | | 40.0 |
| | RG II | | 11.2 | 44.4 | 44.4 | | | | |
| | RG III | 33.4 | 16.7 | | | | 16.7 | | 33.2 |
| | RG IV | | | | | | | | 100 |
| Example 7 | Base | 100 | | | | | | | |
| | RG I | 100 | | | | | | | |
| | RG II | 40.0 | | 20.0 | | | | | 40.0 |
| | RG III | | 11.2 | 34.4 | 34.4 | 10 | | 10 | |
| | RG IV | | | | | | | | 100 |

FIG. 4 shows an embodiment of infrared material 20 as a coating that is applied to a conductor electrode portion 30 inside the PF correction device 6. The conductor portion 30 may be part of either the first electrode 26 or second electrode 21.

As shown, the conductor electrode 30 can be coated with layers of infrared radiating materials, so that infrared radiation emitted from the infrared radiating region 20 penetrate the conductor electrode 30.

The thickness of each layer of infrared radiating material can be from about 0.1 mm to about 1 mm, such as about 0.5 mm. The infrared radiating material used for the coating can include SiO₂ power, carbon, and kiyoseki mineral powder. The wavelengths of the infrared radiation emitted from these materials can be from about 1 μm to about 40 μm, such as from about 3 μm to about 20 μm. For example, as shown, the coating comprises a layer of silicon oxide (SiO₂) 29, a layer of carbon 28, and a layer of kiyoseki mineral 27 that are applied sequentially to the conductor electrode portion 30.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A correction device configured to be coupled to an electrical system, the device comprising:
a set of conductor wiring conducting electricity from the electrical system, wherein the electricity comprises electrons propagating as a matter wave; and
a set of infrared radiation emitters irradiating selected regions of the conductor wiring with infrared radiation having one or more wavelengths that are substantially the same as wavelengths of matter waves of the electrons passing through the conductor wiring.

2. The device of claim 1, wherein the at least one infrared radiating emitter emits infrared radiation with wavelengths that are out of phase with matter waves of the atoms of the conductor wiring.

3. The device of claim 1, wherein the infrared radiation emitters emit different wavelength of infrared radiation in different regions of the conductor wiring.

4. The device of claim 1, wherein the infrared radiation emitters are a ceramic coating on at least a portion of the set of conductor wiring.

5. The device of claim 4, wherein the infrared radiation emitter comprises SiO₂ powder, carbon, or kiyoseki.

6. The device of claim 5, wherein the coating comprises a plurality of layers and the thickness of each layer within the coating is about 0.5 mm.

7. The device of claim 1, wherein the at least one infrared radiation emitter comprises a mixture of infrared radiating materials.

8. The device of claim 7, wherein the infrared radiating materials are at least one of SiO₂ powder, Al₂O₃ powder, Silica, CaCO₃ powder, TiO₂ powder, Fe₂O₃ powder, MgO powder, and kiyoseki mineral.

9. The device of claim 7, wherein the infrared radiating materials emit infrared radiation with emissivity of from about 0.70 to about 0.90 with wavelengths of from about 3 μm to about 20 μm at temperature of about 300° C.

10. The device of claim 7, wherein the infrared radiation emitter is configured to emit infrared radiation at an emissivity from about 0.30 to about 0.80 and wavelengths from about 3 μm to about 6 μm.

11. The device of claim 7, wherein the infrared radiation emitter emit infrared radiation at an emission power from about 3800 W/m² μm to about 5000 W/m² μm.

12. The device of claim 1, wherein electrical output of the device is varied based on a load connected to the electrical system.

13. The device of claim 1, wherein the device further comprises a metal layer configured to electrically shield an interior of the device.

14. An electrical system, comprising:
a power source providing electricity comprising electrons propagating as a matter wave;
at least one correction device configured to receive at least a portion of the electron matter wave, modify the electron matter wave in the electricity based on irradiating infrared radiation into a portion of the electrical system; and
at least one load configured to perform work with the modified electricity.

15. The system of claim 14, wherein the power source comprises an AC power source.

16. The system of claim 14, wherein the system comprises a plurality of correction devices.

17. The system of claim 14, wherein the correction device is integrated with the at least one load.

18. The system of claim 14, wherein the system comprises a plurality of loads.

19. The system of claim 14, wherein the at least one load is physically spaced about 50 feet away from the correction device.

20. A method of improving electrical efficiency, the method comprising:
receiving electricity from a power source, wherein the electricity comprises electrons propagating as a matter wave in a conductor;
exposing a region of the conductor to infrared radiation at sufficient power and at least one wavelength that modifies the electricity based on compensating for distortions in the matter wave caused by the propagation through the conductor; and
providing the modified electricity to a load.
